(19) United States
(12) Patent Application Publication
(10) Pub. No.: US 2007/0072050 A1
(43) Pub. Date: Mar. 29, 2007

(54) Fuel cell

(75) Inventor: Kentaro Nagai, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/508,981

(22) Filed: Aug. 24, 2006

(30) Foreign Application Priority Data
Aug. 26, 2005 (JP) 2005-246062

(51) Int. Cl. H01M 8/02; H01M 4/94

(52) U.S. Cl. 429/38; 429/44

(57) ABSTRACT

A small-sized fuel cell without performance deterioration is provided by a fuel cell unit including: a membrane electrode assembly which has an anode electrode and a cathode electrode provided on both sides of an electrolyte membrane; a diffusion layer for supplying the cathode electrode with air, disposed at the cathode electrode side of the membrane electrode assembly; and an air introducing layer for supplying the diffusion layer with the air, wherein when a total effective area of the electrolyte membrane at the cathode electrode side is A cm², an average current density in an operation state of the fuel cell is I A/cm², and a total area of the air introducing inlet is S cm², a relation of A×I×0.5<S<A×I×2.0 is satisfied.

### BACKGROUND OF THE INVENTION

1. Field of the Invention

The present invention relates to a fuel cell.

2. Description of the Related Art

A representative cross-sectional structure of a polymer electrolyte fuel cell is shown in FIG. 7. The polymer electrolyte fuel cell has a polymer electrolyte membrane 5 at a central part. On one surface of the membrane, an anode electrode (fuel electrode) 15 receiving a fuel supply and constituting an anode, and, on the other surface thereof, a cathode electrode (oxidizer electrode) 16 receiving an oxidizer supply and constituting a cathode, thereby constituting a main body of the fuel cell.

In general, such main body of the fuel cell is collectively called “membrane electrode assembly (MEA)”. The fuel cell is constructed by providing the respective outer sides of the electrodes with diffusion layers 3 and 6 which supply the anode electrode and the cathode electrode with a fuel and an oxidizer, respectively, by diffusion and which collect the generated electric power, and further forming, on still outer sides, flow paths 22 and 27 for supplying the fuel and the oxidizer to the diffusion layers.

The material for the diffusion layer 3 or 6 is generally constituted of a conductive porous member such as a carbon cloth or a carbon paper. Also in a part of the flow path 22 or 27, a porous member of a high porosity such as a metal foam may be utilized as a member for securing a flow path.

The fuel and the oxidizer are supplied through the flow path by utilizing a pressure gradient or a concentration gradient to thereby diffuse through the diffusion layer and reach the anode and the cathode, respectively. At the anode, the fuel which thus reaches the anode is oxidized by an oxidizing effect of a catalyst disposed on the anode electrode to form protons, which move toward the cathode through the polymer electrolyte membrane. The fuel is generally constituted of a gas such as hydrogen, or a liquid such as methanol or ethanol.

At the cathode, an oxidizer such as oxygen which is arrived from the oxidizer flow path through the diffusion layer reacts with the proton which is moved through the electrolyte membrane, thereby generating water. Through such series of chemical reactions, a part of the energy is taken out as an electrical energy.

As described above, water is generated at the cathode by an electric power generating reaction. Such water generally moves in a state of water vapor or liquid water from the cathode through the oxidizer diffusion layer to the flow path, and is discharged. It may also be discharged from the anode side through the MEA.

In case of executing the supply of the fuel or the oxidizer by a pressure gradient, the generated water moves together with the fuel or the oxidizer, and is discharged from a discharge port. In case of utilizing air as the oxidizer and executing the supply by diffusion, the generated water is discharged by a diffusion of water vapor. The fuel cell is incapable of providing a sufficient electric power in a single unit, and generally has a stacked structure in which a plurality of fuel cell units each having the aforementioned structure are connected in series (FIG. 8).

The fuel cell is also anticipated and being developed as a battery for portable electronic instruments such as a notebook personal computer and a personal digital assistant(PDA). In such application, the fuel cell has to be made smaller, and a control mechanism such as a supply device for the fuel or the oxidizer utilizing a gas pressure gradient, may become unusable. In such case, a method of supplying the fuel or the oxidizer by diffusion or natural convection becomes advantageous. For example, U.S. Pat. No. 6,423,437 discloses a technology of a passive type fuel cell in which oxygen in the air to be used as an oxidizer is supplied by a spontaneous diffusion. In this case, hydrogen is supplied from a pressurized tank.

FIG. 4 of U.S. Pat. No. 6,423,437 shows a cell structure in which oxygen in the air to be used as an oxidizer diffuses through a diffusion cell unit and reaches a MEA, while hydrogen to be used as a fuel is supplied through a diffusion layer and reaches the MEA.

In such passive type fuel cell, it is necessary to supply oxygen from an oxidizer inlet, utilizing diffusion due to a concentration gradient, and at the same time to discharge water vapor from the same location, utilizing a concentration gradient. As oxygen in the air is generally utilized as the oxidizer, such location is exposed to the air. Therefore, such passive type fuel cell in which an inlet and an outlet of the flow path can be clearly defined is different from other fuel cells.

In such fuel cell, a larger size of the air introducing inlet does not easily cause deterioration of the characteristics due to diffusion rate-controlling. However, in the case that a compactness is important, particularly in a fuel cell for the portable electronic instrument, a larger size of the air introducing inlet became a factor that inhibits the compaction.

In the passive fuel cell, as described above, the cathode side is exposed to the air, and the oxygen as oxidizer is supplied by a spontaneous diffusion. Therefore, when a region where oxygen cannot diffuse to reach is generated in the cathode, the power generating efficiency in such region becomes lowered or becomes zero.

Also, in a cell as shown in FIG. 9, which lacks portions corresponding to the outlets of the fuel and the oxidizer of the cell shown in FIG. 7, hydrogen as the fuel and oxygen as the oxidizer enter from respective inlets, and are reacted and consumed at the anode electrode and the cathode electrode, respectively. In such cell shown in FIG. 9, the oxygen at the cathode side is basically supplied by only diffusion. Therefore, the reaction at the cathode in a region b relatively distant from the entrance has a lower reaction rate in comparison with a region a.

A larger size of the air introducing inlet reduces influences due to diffusion rate-controlling. However, it is in an antinomy relation with the occupation volume of a whole cell, and a larger air introducing inlet increases the occupation volume of the whole cell, thereby hindering a compaction.

### SUMMARY OF THE INVENTION

The present invention is to provide a polymer electrolyte fuel cell capable of realizing a small-sized structure without deteriorating the characteristics.

More specifically, the present invention provides a fuel cell including: a membrane electrode assembly (MEA) having an anode electrode and a cathode electrode on both sides of an electrolyte membrane; a diffusion layer for supplying the cathode electrode with air by diffusion, disposed at the cathode electrode side of the membrane electrode assembly; an air introducing layer for supplying the diffusion layer with the air; and an air introducing inlet for flowing air into the air introducing layer, wherein when a total effective area of the polymer electrolyte membrane at the cathode electrode side is A cm², an average current density in an operation state of the fuel cell is I A/cm², and a total area of the air introducing inlet is S cm², a relation of A×I×0.5<S<A×I×2.0 is satisfied. Here, the total effective area A of the polymer electrolyte membrane at the cathode electrode side means an area of the MEA which can be supplied with air through the diffusion layer, that is, which can contribute to electric power generation. Further, the total area S of the air introducing inlet means a total area of opening portions through which air can be supplied to one MEA among opening portions on the surface of the cell which are exposed to the air.

Also, the present invention provides a fuel cell including: a membrane electrode assembly which has an anode electrode and a cathode electrode on both sides of an electrolyte membrane; a diffusion layer for supply the cathode electrode with air by diffusion, disposed at the cathode electrode side of the membrane electrode assembly; an air introducing layer for supplying the diffusion layer with the air; and an air introducing inlet for flowing air which is opened to the diffusion layer, wherein when a total effective area of the electrolyte membrane at the cathode electrode side is A cm², and a total area of the air intake aperture is S cm², a relation of A×0.2<S<A ×0.8 is satisfied.

Also, the present invention provides a fuel cell including a plurality of fuel cell units each including: a membrane electrode assembly which has an anode electrode and a cathode electrode on both sides of an electrolyte membrane; a diffusion layer for supplying the cathode electrode with air by diffusion, disposed at the cathode electrode side of the membrane electrode assembly; and an air introducing layer for supplying the diffusion layer with the air, wherein the plurality of the fuel cell units are stacked, an air introducing layer is provided at the cathode electrode of the stacked fuel cell units, the electrolyte membrane has a total effective cathode-side-area of 10 cm² or less, the air introducing layer includes two air introducing inlets opposed to each other for flowing air, and a width of a gap as the air intake layer is from 1 mm or more and 4 mm or less.

The present invention can provide a fuel cell capable of realizing a small-sized structure without deteriorating the performance of the small-sized fuel cell.

Further features of the present invention will become apparent from the following description of exemplary embodiments with reference to the attached drawings.

### BRIEF DESCRIPTION OF THE DRAWINGS

FIG. 1 is a schematic view showing a cross section of a fuel cell of the present invention;

FIG. 2 is a graph showing a dependence of a generated voltage on the current density of a fuel cell unit and on the width of a gap as an air introducing layer of the fuel cell unit;

FIG. 3 is a graph showing a dependence of a generated voltage on a width of a gap as the air introducing layer of the fuel cell unit and on the length of the fuel cell unit;

FIG. 4 is a graph showing a dependence of a generated power per unit volume on the width of a gap as the air introducing layer of the fuel cell unit and on the length of the fuel cell unit;

FIG. 5 is a graph showing a dependence of a generated voltage on the width of a gap as the air introducing layer of the fuel cell unit and on the current density of the fuel cell unit;

FIG. 6 is a graph showing a dependence of a generated power per unit volume on the width of a gap as the air introducing layer of the fuel cell unit and on the current density of the fuel cell unit;

FIG. 7 is a schematic view showing a cross section of a general fuel cell;

FIG. 8 is a schematic view showing a fuel cell stack formed by stacking fuel cell units; and

FIG. 9 is a schematic view showing a cross section of another fuel cell of the present invention.

### DESCRIPTION OF THE EMBODIMENTS

Now the present invention will be described in detail.

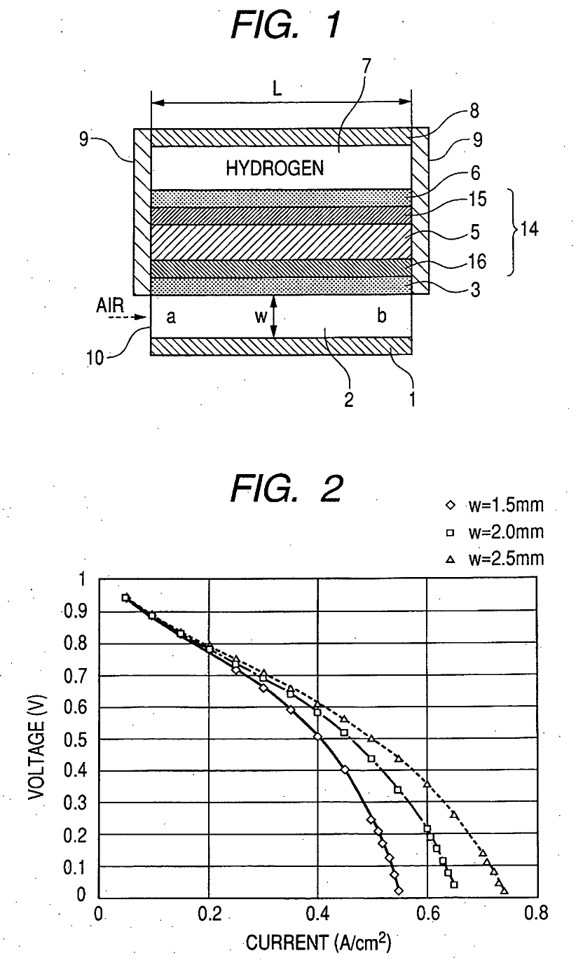

FIG. 1 is a schematic view showing an embodiment of the fuel cell of the present invention. A fuel cell of the present invention includes a membrane electrode assembly 14 which has an anode electrode 15 and a cathode electrode 16 on both sides of an electrolyte membrane 5, an air diffusion layer 3 for supplying the electrode with air by diffusion, disposed at the side of the cathode electrode 16 of the membrane electrode assembly 14, and an air introducing layer 2 for supplying the air diffusion layer 3 with the air from the atmosphere, wherein a total effective area A (cm²) of the electrolyte membrane at the cathode electrode side, an average current density I (A/cm²) in an operation state of the fuel cell and a total area S (cm²) of an air introducing inlet satisfy a relation of A×I×0.5<S<A×I×2.0.

At the side of the anode electrode 15 of the membrane electrode assembly 14, there are provided a fuel diffusion layer 6 for supplying the electrode with a fuel by utilizing diffusion of the fuel, and a fuel introducing layer 7 for supplying the fuel diffusion layer 6 with the fuel.

The fuel cell of the present invention is preferably constructed by stacking a plurality of the fuel cell units as shown in FIG. 8, in such a manner that the air introducing layer is disposed at the side of the cathode electrode of the stacked fuel cell units.

It is more preferable that the air introducing layer is provided parallel or substantially parallel to the fuel cell unit, that the air introducing layer has two air introducing inlets opposed to each other for flowing air, and that a length L (cm) of the electrolyte membrane of the fuel cell unit in a direction parallel to the air flowing direction, an average current density I (A/cm²) in an operation state of the fuel cell, and a width w (cm) of a gap as the air introducing layer satisfy a relation of I×L×0.25<w<I×L×1.0. Also a total effective area of the electrolyte membrane at the cathode electrode side is preferably 10 cm² or less.

Also, the present invention provides a passive type fuel cell which includes an anode layer and a cathode layer on both sides of an electrolyte membrane, in which a fuel is supplied to the anode side while an oxidizer is supplied to the cathode side, and the fuel and the oxidizer are reacted to generate an electric power, in which at least either of the anode and the cathode of the fuel cell includes at least a diffusion layer, in a path for supplying the fuel or the oxidizer, for causing a diffusion of such chemical species and in which the oxidizer is oxygen and oxygen in the atmosphere is taken into from an introducing inlet of the fuel cell mainly by diffusion, wherein a total effective area A (cm²) of the electrolyte membrane at the cathode side and a total area S (cm²) of the air introducing inlet satisfy a relation of A×0.2<S <A×0.8.

It is more preferable that the air introducing layer is provided parallel or substantially parallel to the fuel cell unit, that the air introducing layer has two air introducing inlet faces opposed to each other for flowing air and that a length L (cm) of the electrolyte membrane of the fuel cell unit in a direction parallel to the air flowing direction, and a width w (cm) of a gap as the air introducing layer satisfy a relation of L×0.1<w<L×0.4.

Also, the present invention provides a portable fuel cell formed by a stack of fuel cell units, which includes an anode layer and a cathode layer on both sides of a polymer electrolyte membrane, in which a fuel is supplied to the anode side while an oxidizer is supplied to the cathode side, and the fuel and the oxidizer are reacted to generate an electric power, in which the electrolyte membrane has a total effective area at the cathode side of 10 cm² or less, in which at least either of the anode and the cathode of the fuel cell includes at least a diffusion layer, in a path for supplying the fuel or the oxidizer, for causing a diffusion of such chemical species and in which the oxidizer is oxygen and oxygen in the air is taken into from an introducing inlet of the fuel cell mainly by diffusion, wherein a gap constituting the air introducing layer having an air introducing inlet opened in a direction perpendicular to a stacking direction has a width of from 1 mm or more and 4 mm or less.

In the following, embodiments of the present invention will be explained with reference to the accompanying drawings.

Embodiment 1

The fuel cell of the present embodiment is based on the fuel cell as shown in FIG. 1, and has a cross-sectional structure of a fuel cell unit (hereinafter simply referred to as “cell unit”) having a rectangular parallelepiped shape which is similar to the fuel cell unit as shown in FIG. 8 as an example of a small-sized passive type fuel cell. Hydrogen is supplied in vertical direction in FIG. 1 to the anode side, and oxygen-containing air as the oxidizer is supplied in lateral direction in FIG. 1 to the cathode side. The hydrogen is considered free from an influence by a concentration since it is assumed that pure hydrogen is always supplied in stable manner, while, at the cathode side, the reaction rate is subject to an influence of concentration, since oxygen is supplied by diffusion.

Reaction characteristics of a standard fuel cell have been applied to simulate an efficiency of an entire cell unit by a fluid simulator, utilizing a finite element method (FEM). As a membrane electrode assembly in the simulation, there has been applied a condition of reproducing a catalytic reaction on a MEA formed by adhering platinum black on Nafion 112 (trade name of DuPont de Nemeurs). As the diffusion layer, a carbon cloth of a thickness of 0.50 mm has been assumed. It has been assumed to use pure hydrogen as the fuel gas, oxygen as the oxidizer, and that water vapor has been generated by a catalytic reaction at the cathode and discharged by diffusion from the air introducing inlet.

FIG. 2 shows a graph of I-V characteristics obtained in a two-dimensional simulation with a length L of 20 mm of the electrolyte membrane in a direction parallel to the air flowing direction, and as a function of a width w of a gap as the air introducing layer (hereinafter simply referred to as “gap”). An approximately same voltage is obtained in any width of the gap in a low current density region where the oxygen consumption is relatively low, but the voltage becomes lower for a smaller width of the gap in a high current density region of 0.4 A/cm² or higher. This indicates generation of diffusion rate-controlling phenomenon that the consumption of oxygen cannot be covered by the supply by diffusion in a smaller gap.

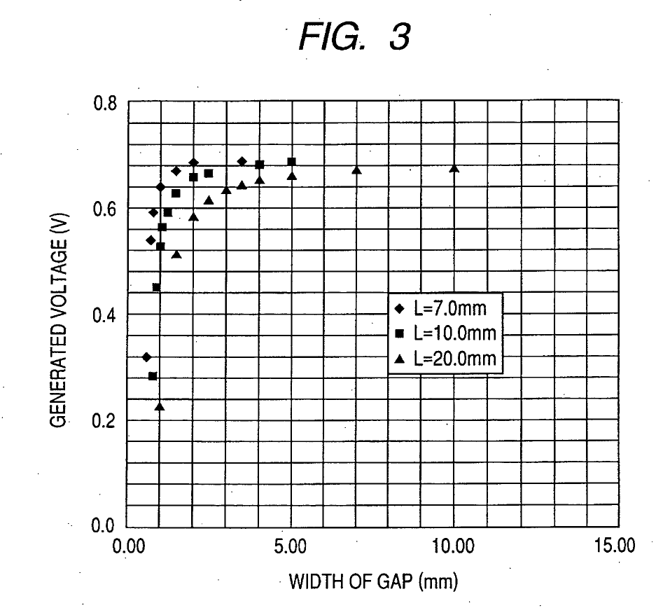

However, the characteristics are not improved in proportion to an increasing size of the gap. When the gap is beyond a certain size, the effect of size of the gap becomes very limited. FIG. 3 is a graph showing the result of a simulation for a change in the characteristics (generated voltage) with different widths of the gap under a certain constant generated current (generated current density I=0.4 A/cm²). FIG. 3 shows that in all the lengths of the electrolyte membrane, the voltage is inversely proportional to the width of the gap, and the increase in the voltage is saturated beyond a certain gap.

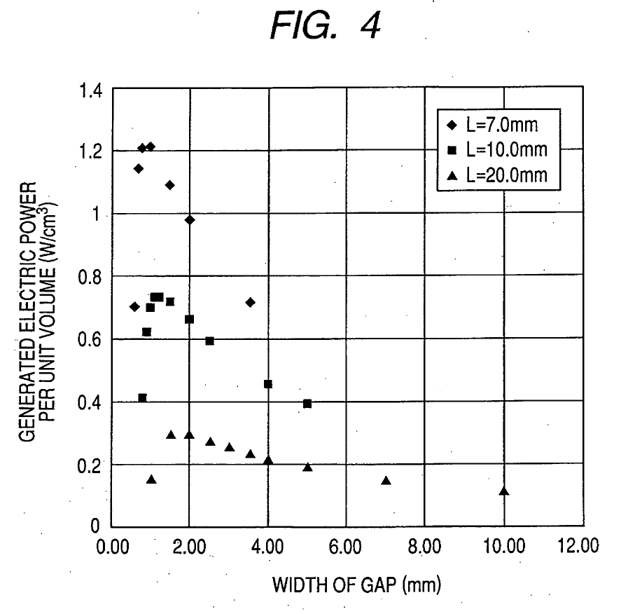

Then, a comparative investigation has been made on the generated electric power per a unit volume. FIG. 4 is a graph, plotting a value obtained by determining a volume of a cell unit with an assumption that the anode part of the fuel cell has a thickness of 2 mm and by dividing the generated electric power by the volume of the cell unit. It can be observed that the generated electric power per unit volume becomes larger when the gap has a width of about 1 mm to 2 mm, but tends to decrease at a larger width of the gap. Thus there is obtained a principle of designing the width of the gap so as to maximize the generated electric power per unit volume even if the characteristics of the unit cell cannot be exploited by 100%.

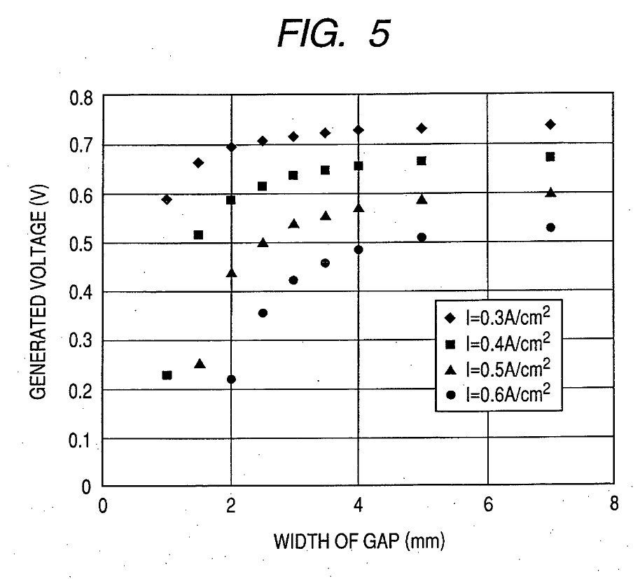

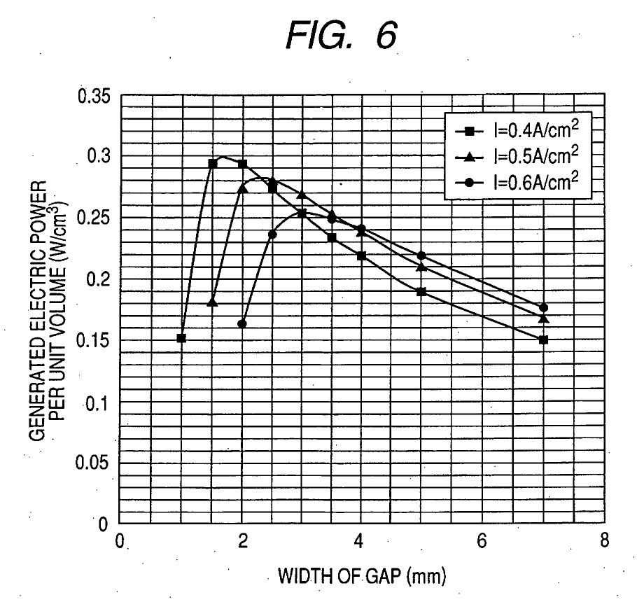

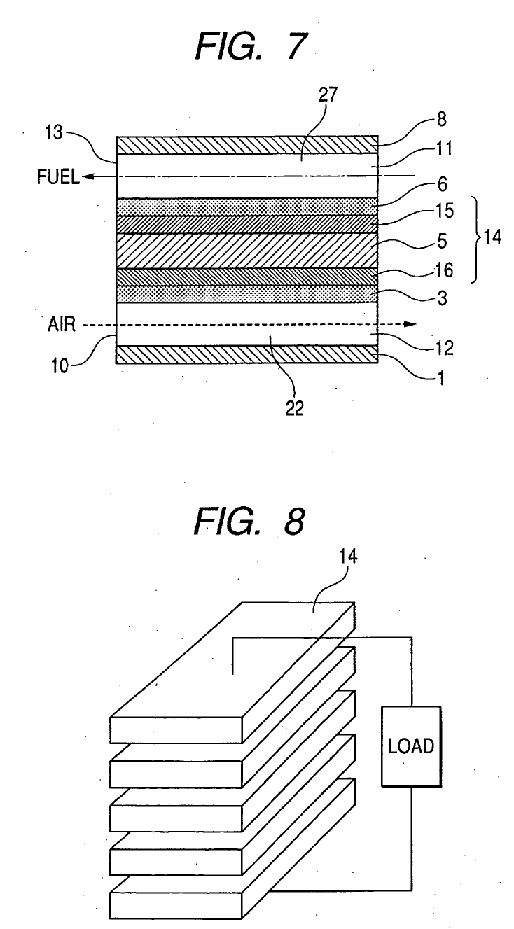

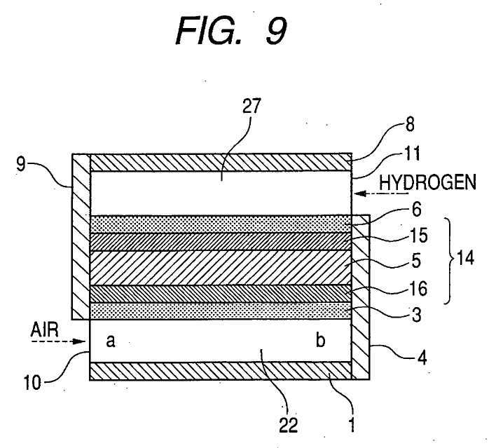

The aforementioned saturation state changes by a change in the generated current. FIG. 5 shows a plotting of a dependence of the generated voltage on the gap, when the cell length L is set at 2.0 cm. The plotted results show a general shift toward a lower right direction, with an increase in the current density. This is due to an increase in the necessary oxygen amount, caused by an increase in the current density. Also FIG. 6 shows a plotting of the generated electric power per unit volume, in a similar manner as described above.

Followings can be concluded from the foregoing data. In the present embodiment, based on FIG. 4, the generated electric power per unit volume becomes largest when a cell length L and a width w of the gap satisfy
w=L×0.1 (1).

In this simulation, since the air introducing inlet are provided in two locations, a width W of an effective air introducing inlet is represented by:
W=2w=L×0.2 (2).

When both side of this equation are multiplied by the width of cell unit, as described below, this equation may be substituted by the aforementioned relation between the total effective area A of the electrolyte membrane at the cathode side and the total area S of the air introducing inlet:
S=A×0.2 (3).

That is, it is clearly found that in a polymer electrolyte fuel cell, a sufficient performance can be obtained when the total area of the air introducing inlet in the fuel cell is 0.2 times or more of the total effective area of the electrolyte membrane at the cathode side.

In addition, it is read in FIG. 4 that a value of a half the maximum value of the generated electric power per unit volume is a value of 4 times the width of the gap when the generated electric power per unit volume becomes maximum. On the contrary, in the case of the width of the gap smaller than a width of the gap when the generated electric power per unit volume becomes the maximum, the generated electric power per unit volume rapidly reduces. From these points, it is found that the relation of a width w (cm) of a gap and a length L (cm) of the cell unit to be preferably used in a practical use satisfies the following relation:
L×0.1<w<L×0.4 (4).

Similarly as in the above, it is found that the relation of the total effective area A (cm²) of the electrolyte membrane at the cathode side and the total area S (cm²) of the air introducing inlet to be preferably used in a practical use satisfies the following relation:
A×0.2<S<A×0.8 (5).

Now, a width of the gap necessary for a current density I (A/cm²) is considered based on FIGS. 5 and 6. It can be found that, in the case where the current density I is increased from 0.4 A/cm² in FIG. 6, a width of the gap when the generated electric power per unit volume becames maximum increase proportionally.

This is, it can be said that the necessary width of the gap is proportional to the length L of the cell unit and is proportional to the current density I. In a summary of the foregoing, in designing a cell having a total effective area A of the electrolyte membrane at the cathode side and having a current density I, the necessary total area S of the air introducing inlet is proportional to the total current AI, namely:
S=αAI (6).

Here, α denotes a proportional constant. It is found that when I=0.4 A/cm² is applied to the equation (3), the value of the proportional constant a satisfying S =A×0.2 at I=0.4 is suitably 0.5.

The relation of the total effective area A (cm²) of the electrolyte membrane at the cathode side and the total area S (cm²) of the air introducing inlet to be preferably used in a practical use is obtained. By using the same arguments as in obtaining the relation (5) from FIG. 4, it is read that a value of a half the maximum value of the generated electric power per unit volume is a value of 4 times the width of the gap when the generated electric power per unit volume becomes maximum. On the contrary, in the case of the width of the gap smaller than a width of the gap when the generated electric power per unit volume becomes the maximum, the generated electric power per unit volume rapidly reduces. From these points, it is found that
A×I×0.5<S<A×I×2.0 (7).

Similarly, it is found that the relation of a width w (cm) of the gap and a length L (cm) of the cell unit to be preferably used in a practical use satisfies the following relation:
I×L×0.25<w<I×L×1.0 (8).

Thus, the width of the gap indicates a width necessary for securing an area of the air introducing inlet for a predetermined generated electric power, and this rule is applicable to design not only the cell unit of a rectangular parallelepiped shape as in the present embodiment but also the cell unit having a circular shape.

Based on the foregoing, therefore, in designing a passive type fuel cell, the air introducing inlet at the cathode side can be designed by at first determining a desired current amount, and then by making a calculation so as to satisfy the relations of the present invention. The I-V characteristics themselves are dependent on the performance of the electrolyte membrane with catalyst layer, constituting the membrane electrolyte assembly (MEA), but, in the case where a certain current is desired as a specification of a fuel cell, since the necessary oxygen amount is determined by the current, the structure does not directly depend on the characteristics of the MEA but depends on only the current amount. Keeping this fact in mind, it is possible to determine a necessary area of the air introducing inlet for the necessary current, thus reflecting on the designing of the width of the gap.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent application No. 2005-246062 filed on Aug. 26, 2005, which is hereby incorporated by reference herein.

What is claimed is:

1. A fuel cell comprising:
a membrane electrode assembly comprising an electrolyte membrane, and an anode electrode and a cathode electrode provided on both sides of the electrolyte membrane;
a diffusion layer for supplying the cathode electrode with air, disposed at a cathode electrode side of the membrane electrode assembly; and
an air introducing inlet for supplying the diffusion layer with the air,
wherein when a total effective area of the electrolyte membrane at the cathode electrode side is A cm², an average current density in an operation state of the fuel cell is I A/cm², and a total area of the air introducing inlet is S cm², a relation of A×I×0.5<S<A×I×2.0 is satisfied.

2. A fuel cell according to claim 1, further comprising an air introducing layer parallel to the electrolyte membrane, wherein the air introducing layer has two faces thereof opposed to each other and opened to the atmosphere for flowing air, and wherein when a length of the electrolyte membrane of the fuel cell is L cm, an average current density in an operation state of the fuel cell is I A/cm², and a width of a gap as the air introducing layer is w cm, a relation of I×L×0.25<w<I×L×1.0 is satisfied.

3. A fuel cell comprising:
a membrane electrode assembly comprising an electrolyte membrane, and an anode electrode and a cathode electrode provided on both sides of the electrolyte membrane;
a diffusion layer for supplying the cathode electrode with air, disposed at a cathode electrode side of the membrane electrode assembly; and
an air introducing inlet for supplying the diffusion layer with the air,
wherein when a total effective area of the electrolyte membrane at the cathode electrode side is A cm², and a total area of the air introducing inlet is S cm², a relation of A×0.2<S<A×0.8 is satisfied.

4. A fuel cell according to claim 3, further comprising an air introducing layer parallel to the electrolyte membrane, wherein the air introducing layer has two faces thereof opposed to each other and opened to the atmosphere for flowing air, and wherein a length of the electrolyte membrane of the fuel cell is L cm, and a width of a gap as the air introducing layer is w cm, a relation of L×0.1<w<L×0.4 is satisfied.
